(19) United States
(12) Patent Application Publication
(10) Pub. No.: US 2019/0184341 A1
(43) Pub. Date: Jun. 20, 2019

(54) METHOD FOR PREPARATION OF HOLLOW FIBER MEMBRANE DEVICES AND THE USE THEREOF

(71) Applicants: L'Air Liquide, Societe Anonyme Pour I' Etude et I' Exploitation des Procedes Georges Claude, Paris (FR); Air Liquide Advanced Technologies U.S, LLC, Houston, TX (US)

(72) Inventors: Moutushi Dey, Garnet Valley, PA (US); Matthew Metz, Bear, DE (US); James Macheras, Quincy, MA (US); Benjamin Bikson, Newton, MA (US); Tao Li, Garnet Valley, PA (US)

(73) Assignees: L'Air Liquide, Societe Anonyme Pour I' Etude et I' Exploitation des Procedes Georges Claude, Paris (FR); Air Liquide Advanced Technologies U.S, LLC, Houston, TX (US)

(21) Appl. No.: 16/223,535

(22) Filed: Dec. 18, 2018

Related U.S. Application Data
(60) Provisional application No. 62/607,049, filed on Dec. 18, 2017.

(51) Int. Cl. B01D 63/02; F25J 3/00

(52) U.S. Cl. CPC B01D 63/025; F24F 13/28; F25J 3/00

(57) ABSTRACT

The invention is directed to preparation of hollow fiber membrane devices that exhibit improved durability and mechanical strength in air separation operations such as generation of nitrogen enriched air on board aircraft. In particular the invention provides for preparation of hollow fiber membrane modules with terminal tubesheets of superior mechanical properties and improved long term durability in air separation operations.

### CROSS-REFERENCE TO RELATED APPLICATIONS

This application claims the benefit of U.S. Provisional Application No. 62/607,049, filed Dec. 18, 2017.

### BACKGROUND

### Field of the Invention

The present invention relates to preparation of hollow fiber membrane devices that exhibit improved durability and mechanical strength in air separation operations such as the generation of nitrogen enriched air on board aircraft.

### Related Art

Hollow fiber devices for fluid separations are well known in the art. Hollow fiber membrane chemistry, morphology, device design and construction methods are optimized for specific separation application. Hollow fiber devices are used extensively in gas separation applications including the generation of oxygen or nitrogen enriched gas streams from air. To generate nitrogen enriched air an air stream is directed into a hollow fiber membrane device under conditions wherein a pressure differential exists between the shell side and the bore side of the hollow fibers, thereby enabling selective permeation of oxygen to the low pressure side and collection of nitrogen enriched air on the high pressure side. One example of membrane air separation application is the generation of nitrogen enriched air on board aircraft for fuel tank inerting. An Air Separation Module (ASM) constructed of hollow fiber membranes is commonly used to generate nitrogen enriched air. In the aircraft fuel tank inerting process the air at an elevated pressure is directed into the bores of hollow fibers at the first end of the ASM, the oxygen enriched air is collected on the shell side of hollow fibers, and the nitrogen enriched air is collected as a non-permeate gas on the bore side of hollow fibers at the second distal module end.

Separation devices utilizing hollow fiber membranes typically have a tubular configuration and are commonly classified as a bore side or shell side feed device. The device includes a tubesheet at one or both ends of a cylindrical construction and is made of a bundle of hollow fibers embedded in a resinous matrix. Examples of hollow fiber module designs can be found in U.S. Pat. Nos. 3,422,008; 3,690,465; 3,755,034; 4,061,574; 4,080,296; 5,013,437; 5,837,033; 6,740,140 and 6,814,780.

Integral parts of hollow fiber devices are terminal tubesheets. Hollow fiber modules are comprised of an annular hollow fiber bundle with terminal ends encapsulated by a resinous material to form tubesheets. Tubesheets separate the high pressure side from the low pressure side of the hollow fiber membranes. Tubesheets are designed to provide a fluid tight seal between the shell side and the bore side of hollow fibers in the device. A breach of tubesheet integrity will compromise the operation of the device.

The hollow fiber bundle within the membrane module is typically uniformly structured to improve flow dynamics and aid separation efficiency. For example, uniform fluid flow distribution is frequently accomplished by controlled and uniform distribution of hollow fiber packing density. Examples of structured hollow fiber devices construction methods can be found in U.S. Pat. Nos. 3,690,465; 3,755,034; 4,800,019; 4,881,955; 4,865,736, 5,284,584 and 5,897,729. One particularly advantageous method of constructing hollow fiber devices with controlled and uniform distribution of fiber packing density is by fiber helical winding methods. Description of such methods can be found in, for example, U.S. Pat. Nos. 3,794,468; 4,207,192; 4,336,138; 4,430,219; 4,631,128 and 4,881,995.

A terminal tubesheet is a critical component of every hollow fiber device. Generally, tubesheets are formed from curable resinous materials such as epoxy or polyurethane resins or thermoplastic materials such as polyethylene or polypropylene. During operation of the hollow fiber ASM device a pressure differential exists between the bore side of hollow fibers and the shell side of hollow fibers. The differential pressure generates a load on the tubesheet that can lead to a rupture or to deformation due to creep and thus lead to a premature failure of the device. Exposure of the tubesheet to aggressive chemicals or oxidizers (such as ozone) present in the feed gas can also degrade mechanical properties of tubesheets. The problem is further exacerbated at high operating temperatures, since high operating temperatures often decrease the tensile strength of materials, thereby leading to tubesheet failure. Due to the aforementioned conditions, the useful life of the hollow fiber device, the maximum operating pressure capability, and the maximum operating temperature capability of the hollow fiber device may be limited.

Hollow fibers deployed in gas separation applications can be of asymmetric or composite structure. The wall of a hollow fiber is porous with the exterior thin surface layer being substantially non-porous. This exterior thin surface layer exhibits the prerequisite gas separation characteristics.

It is a universal feature of all tubesheet construction that the surfaces of the hollow fibers are in direct contact with the resinous material that encapsulates hollow fibers to form a composite structure. The most common encapsulating tubesheet construction material is an epoxy resin, wherein an interface is formed at the fiber surface and the epoxy resin.

In air separation operation, the feed gas is introduced into the bores of the hollow fibers and the permeate gas (which is enriched in the fast gas permeating components such as oxygen) permeates through the fiber wall and is withdrawn from the exterior (i.e., shell side) of hollow fibers. Thus, the feed gas thus comes into contact with the hollow fiber/epoxy interface through the porous wall of the hollow fiber. If the feed gas contains aggressive components that are deleterious to the mechanical properties of the materials with which the tubesheet is constructed, it can lead to a premature tubesheet failure. This in turn leads to a loss of the hollow fiber device's gas separation efficiency. The aggressive components may include oxidizing components such as ozone, oxygen present in air (when in combination with heat and moisture) or other gases that degrade the hollow fiber/epoxy interface, thereby reducing the mechanical properties of the composite fiber/epoxy tubesheet. This loss of mechanical properties leads to a premature tubesheet failure and loss of the device's gas separation efficiency.

Hollow fiber membrane devices are used in a broad range of gas separation applications. One extensively used gas separation application is the use of hollow fiber membrane modules to separate oxygen from air to generate nitrogen enriched or oxygen enriched air stream. The nitrogen enriched air generated by the membrane device has found utility in generating inert atmospheres, including those used for flammability reduction on board aircraft.

An aircraft fuel tank flammability reduction process includes feeding pressurized air into the ASM containing the gas separation membrane capable of separating oxygen from nitrogen by selective oxygen permeation. The process includes contacting the separation membrane with the high pressure air feed stream, generating a low pressure oxygen enriched stream by preferentially permeating oxygen from the feed air stream through the gas separation membrane, and producing non-permeate nitrogen-enriched air from the air separation module as a result of removing oxygen from the feed air. The nitrogen-enriched air is fed into the fuel tank on board the aircraft. During ASM operation. aggressive components in the feed air stream can degrade the tubesheet strength that in turn can lead to premature device failure. The feed tubesheet typically is affected preferentially. The premature failure of the ASM feed tubesheet is the result of a failure of the hollow fiber/epoxy matrix at the interface of the epoxy and the outer surface of the fibers such that fibers are caused to be de-bonded from the epoxy of the matrix. The result of this de-bonding creates either a leak of the feed gas to the permeate gas or a feed tubesheet failure due to insufficient strength of the tubesheet to withstand the stresses of the ASM during operation.

It may be required to pre-treat the feed air to remove components harmful to tubesheet materials. An example of pretreatment process is described in US 2014/0116249. However, such pre-treatment can add to the system size, cost and complexity.

The tubesheet life can be substantially shortened if the device is subjected to the high loads that are typical for large size/large diameter hollow fiber devices. Tubesheets with improved mechanical properties enable constriction of larger size hollow fiber devices without a need for additional support structures to prevent creep and premature rapture of tubesheets.

A number of solutions have been proposed in the art to improve capability of air separation devices to withstand the differential load. For example, U.S. Pat. No. 7,717,983 describes an air separation module with a load carrying central tube. U.S. Pat. No. 9,186,628 describes an air separation module with a clam shell axial support. While the gas introduction and gas withdrawal in ASM devices is commonly carried out in an axial tubesheet configuration, an alternative radial design that decreases the load on tubesheets is disclosed in U.S. Pat. No. 9,084,962. The feed gas and non-permeate gas are introduced into or removed from the hollow fiber membrane tubesheets via a plurality of radial through openings formed in the tubesheet.

The source of feed air to an ASM on board aircraft is typically bleed air from the aircraft engine. This feed air can contain chemical components that can affect the mechanical integrity of tubesheets and polymeric membranes and thus lead to a premature failure of the ASM. To protect the ASM from harmful components that may be present in the feed air, it has been proposed in US 2017/0015433 A1 to treat the feed air with a contaminant removal system that can catalytically decompose harmful components present in the feed air. However, such a system adds weight and operational complexity.

Thus, a need still exists in the art to improve ASM durability by constructing tubesheets that may be operated in harsh, high temperature environments without extensive load carrying support structures or pretreatment systems.

### SUMMARY

There is disclosed an aircraft fuel tank flammability reduction method that includes the following steps. Pressurized air is fed into hollow fiber membrane air separation module comprising one or more cured tubesheets disposed at a terminal end(s) of the module and also one or more hollow fiber membranes, each of the tubesheets comprising resin encapsulating the membrane(s), each of the membrane(s) having a bore, the hollow fiber membrane(s) being capable of selective oxygen permeation. The pressurized air is allowed to be fed into bore(s); removing some of the oxygen from the feed air as an oxygen-enriched permeate stream from the air separation module so as to produce nitrogen-enriched air as a non-permeate stream from the air separation module, wherein access of feed air to an interface between an exterior surface of the hollow fibers and the encapsulating resin within the tubesheet is restricted.

There is disclosed another aircraft fuel tank flammability reduction method that includes the following steps. Pressurized air is fed into hollow fiber membrane air separation module that includes one or more cured tubesheets disposed at a terminal end(s) of the module and also one or more hollow fiber membranes, each of the tubesheets comprising resin encapsulating the membrane(s), each of the membrane(s) having a bore, the hollow fiber membrane(s) being capable of selective oxygen permeation. The pressurized air is allowed to be fed into bore(s). Some of the oxygen is removed from the feed air as an oxygen-enriched permeate stream from the air separation module so as to produce nitrogen-enriched air as a non-permeate stream from the air separation module, wherein pores of walls of the membrane(s) within at least one tubesheet of the module have been blocked by a material that limits access of the feed air to an interface between an exterior surface of the hollow fibers and the encapsulating resin within the tubesheet.

There is disclosed yet another aircraft fuel tank flammability reduction method that includes the following steps. Pressurized air is fed into hollow fiber membrane air separation module comprising one or more cured tubesheets disposed at a terminal end(s) of the module and also one or more hollow fiber membranes, each of the tubesheets comprising resin encapsulating the membrane(s), each of the membrane(s) having a bore, the hollow fiber membrane(s) being capable of selective oxygen permeation. The pressurized air is allowed to be fed into bore(s). Some of the oxygen is removed from the feed air as an oxygen-enriched permeate stream from the air separation module so as to produce nitrogen-enriched air as a non-permeate stream from the air separation module, wherein the encapsulating resin of at least one of the tubesheet(s) penetrates into porous walls of hollow fibers in the tubesheet limiting access of the feed air to an interface between an exterior surface of the hollow fibers and the encapsulating resin within the tubesheet(s).

There is yet another aircraft fuel tank flammability reduction method that includes the following steps. Pressurized air is fed into hollow fiber membrane air separation module comprising one or more cured tubesheets disposed at a terminal end(s) of the module and also one or more hollow fiber membranes, each of the tubesheets comprising resin encapsulating the membrane(s), each of the membrane(s) having a bore, the hollow fiber membrane(s) being capable of selective oxygen permeation. The pressurized air is allowed to be fed into bore(s). Some of the oxygen is removed from the feed air as an oxygen-enriched permeate stream from the air separation module so as to produce nitrogen-enriched air as a non-permeate stream from the air separation module, wherein at least one tubesheet has been treated to render walls of the hollow fiber(s) in the tubesheet denser to limit access of the feed air to an interface between exterior surfaces of the hollow fiber(s) and the encapsulating resin within the tubesheet.

Any one of the above methods may include one or more of the following aspects:

pores of walls of the membrane(s) within at least one tubesheet of the module have been blocked by a material that limits access of the feed air to an interface between an exterior surface of the hollow fibers and the encapsulating resin within the tubesheet.

the encapsulating resin of at least one of the tubesheet(s) penetrates into porous walls of hollow fibers in the tubesheet limiting access of the feed air to an interface between an exterior surface of the hollow fibers and the encapsulating resin within the tubesheet(s).

at least one tubesheet has been treated to render walls of the hollow fiber(s) in the tubesheet denser to limit access of the feed air to an interface between exterior surfaces of the hollow fiber(s) and the encapsulating resin within the tubesheet.

the nitrogen-enriched air is directed into the fuel tank on board an aircraft.

the tubesheet is the feed gas side tubesheet.

at least 50% of a pore volume of the hollow fiber membrane(s) in the tubesheet are filled with encapsulating resin.

at least 90% of a pore volume of the hollow fiber membrane(s) in the tubesheet are filled with encapsulating resin.

the impregnation of porous walls is substantially uniform across a diameter of the tubesheet and tubesheet thickness.

a temperature of the feed air is between 45 and 120° C.

the material that limits access of air to interface between hollow fibers and encapsulating resin is deposited from a solution through the hollow fiber bore(s).

the material is an inorganic substance or a polymer.

the material is a polymer having an oxygen gas permeability coefficient below 1 Barrer.

a pore volume of portions of the hollow fiber(s) in the tubesheet is reduced by at least 50% compared to remaining portions of the hollow fiber(s).

a pore volume of portions of the hollow fiber(s) in the tubesheet is reduced by at least 80% compared to remaining portions of the hollow fiber(s).

the resin completely encapsulates the hollow fibers and substantially penetrates and saturates the porous walls of hollow fibers such that they are rendered non-porous.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is schematic diagram of the cross sectional view of a conventional hollow fiber tubesheet wherein pores in hollow fiber walls are shown to be substantially free of encapsulating resin.

FIG. 2 is schematic diagram of the cross sectional view of a hollow fiber tubesheet of this invention wherein the pores in hollow fiber walls are filled with the encapsulating resin. The hollow fiber bore are open and allow for unobstructed flow of the feed gas into hollow fibers.

FIG. 3 is photo micrograph of cross-sectional view of a composite hollow fiber/epoxy tubesheet manufactured by conventional methods.

FIG. 4 is photo micrograph of cross-sectional view of a composite hollow fiber/epoxy tubesheet according to the present invention

### DESCRIPTION OF PREFERRED EMBODIMENTS

It is one object of this invention to provide tubesheets that exhibit improved mechanical characteristics in gas separation operations.

It is another object of this invention to provide tubesheets that exhibit improved durability in gas separation operations wherein the feed gas contains aggressive oxidizing components and other gas components deleterious to tubesheet's materials strength.

It is a further object of this invention to prepare hollow fiber membrane device that exhibits improved durability and mechanical characteristics in air separation service on board aircraft. The present invention relates to air separation systems and in particular to a nitrogen generation system (NGS) on board aircraft. The key component of nitrogen generation system is ASM that separates the feed air into nitrogen enriched air (NEA) for fuel tank blanketing and oxygen enriched air (OEA). The ASM includes a polymeric gas separation membrane which separates the feed air into NEA and OEA. Tube sheets are a critical structural component of the ASM that separate the feed air stream and the residue NEA gas stream from the permeate (OEA) stream in a fluid-tight arrangement. Any breach of tubesheet integrity can lead to ASM failure. The tubesheet is typically formed by impregnating hollow fiber membrane bundles or sheets with the resinous potting material.

It was found surprisingly that objects of this invention can be met by a tubesheet that restricts access of feed air to the interface between the exterior surface of the hollow fiber and the encapsulating resin. This may be accomplished by any one or more of three techniques.

In a first technique, the tubesheets are constructed with the resin completely encapsulating the hollow fibers and substantially penetrating and saturating the porous walls of hollow fibers such that they are rendered non-porous. It is critical feature of the first technique that the impregnation of the pores in hollow fiber walls by the resin is accomplished without blocking the bores of the hollow fibers. The tubesheets of this particular embodiment do not contain a sharp delineating interface between the porous hollow fiber surface and the encapsulating resin as exhibited by conventional tubesheets.

Typically, more than 50% of the pore volume of the hollow fibers is saturated with the encapsulating resin, and more typically, more than 90% of the pore volume is saturated with the encapsulating resin. Surprisingly the impregnation can be accomplished without the resin penetrating into bores of hollow fibers and thus blocking the flow of gases and affecting the gas separation operation.

Regardless of the degree of saturation of the pores, the encapsulating resin typically substantially penetrates and substantially saturates the walls of hollow fibers without dissolving the hollow fibers, without blocking the bores of hollow fibers, and without generating an excessive exotherm during curing and post curing of the encapsulating resin.

When used in gas separation applications, the polymeric material of the hollow fibers are typically formed by a solution-based fabrication process or by melt processing. Hollow fibers formed by the solution-based processes can be plasticized or even dissolved by some resin materials used in conventional tubesheet preparation. Hollow fibers formed from thermoplastic materials can melt at elevated temperatures that may occur during curing and post curing tubesheet preparation steps. With this in mind, the preferred encapsulating resinous materials are epoxy resins.

Epoxy resins include but are not limited to Bisphenol A, Bisphenol F, Novolac, Aliphatic epoxy, Glycidylamine epoxy among others as known in the art. Curing agents (for curing of the epoxy resin) include but are not limited to amines, anhydrides, phenols and thiols among others as known in the art. Typically, the curing agents are aliphatic, cyloaliphatic or aromatic amines. Some particular examples of curing agents include diethyl toluene diamine (DETDA), methylenebis(cyclohexylamine) (MBCHA) and mixtures thereof. The uncured epoxy resin composition will typically exhibit a relatively low viscosity in order to enable complete impregnation of tubesheet structure and infusion of the composition into the porous fiber walls. Typically, the resin viscosity is below 1000 cps at 35° C., more typically below 700 cps at 35° C.

The impregnation of the fibers by the epoxy resin to form the tubesheet can be carried out by methods well known in the art including centrifugal casting or injection. The tubesheets are cured in order to solidify the resin and subsequently are post cured at elevated temperature to impart desired mechanical properties. The post curing process may include a staged temperature ramp up, high temperature soak and/or a controlled temperature down ramp. The post curing process can be further carried out under vacuum or in a controlled atmosphere such as in a nitrogen atmosphere.

Infusing porous walls of hollow fibers within the tubesheet with the resinous potting material generates mechanical interlock and improves mechanical properties and the durability of the tubesheet. Tubesheets made with the resinous potting material impregnating porous walls of hollow fibers show significant improvement of mechanical properties as compared to prior art tubesheets. The tensile strength of the tubesheet can increase by more than 50% and in some cases by as much as 120%.

Tubesheets of present invention can be prepared by impregnating hollow fibers with the resinous potting material by a conventional casting. The impregnation can be further carried out by centrifugal casting or resin injection as well known in the art. The infusion of porous walls with the resin is aided by using formulations of low viscosity. Preferably the resin viscosity is below 1000 cps at 35° C., most preferably the resin viscosity is below 700 cps at 35° C.

It is further desirable in addition to generating mechanical interlock to maximize physical and chemical adhesion between fiber and resin. The later can be accomplished by adding coupling agents such as aminosilanes to the resin formulation as is well known to those skilled in the art. Silanes are well known as adhesion promoter and widely used for increasing adhesion in fiber/resin polymeric composites. Preferred silanes used for increasing adhesion between fibers and the resin include N-beta-(aminoethyl)-gamma-aminopropyltrimethoxysilane, N-beta-(aminoethyl)-gamma-aminopropyl-methyldimethoxysilane, 3-aminopropyl-triethoxysilane, dimethyldimethoxysilane, phenyltrimethoxysilane, and gamma-glycidoxypropyltrimethoxysilane among others.

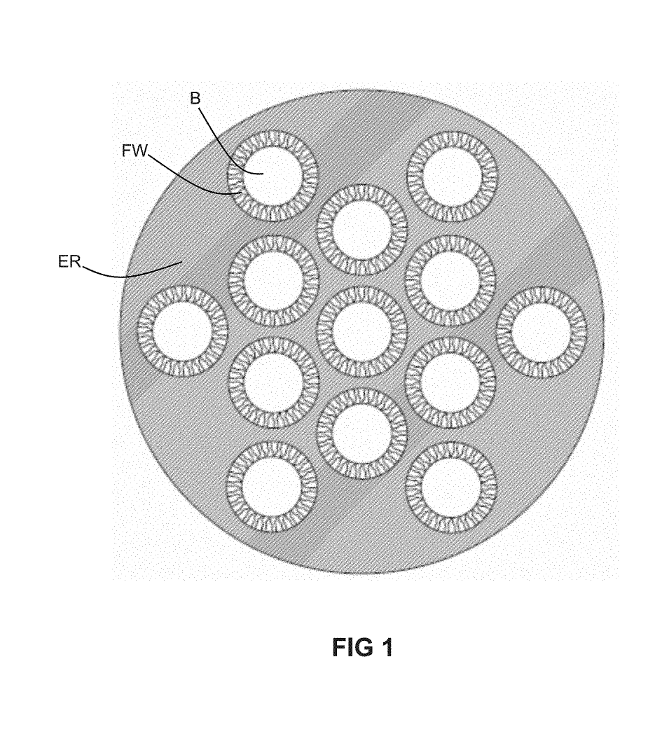

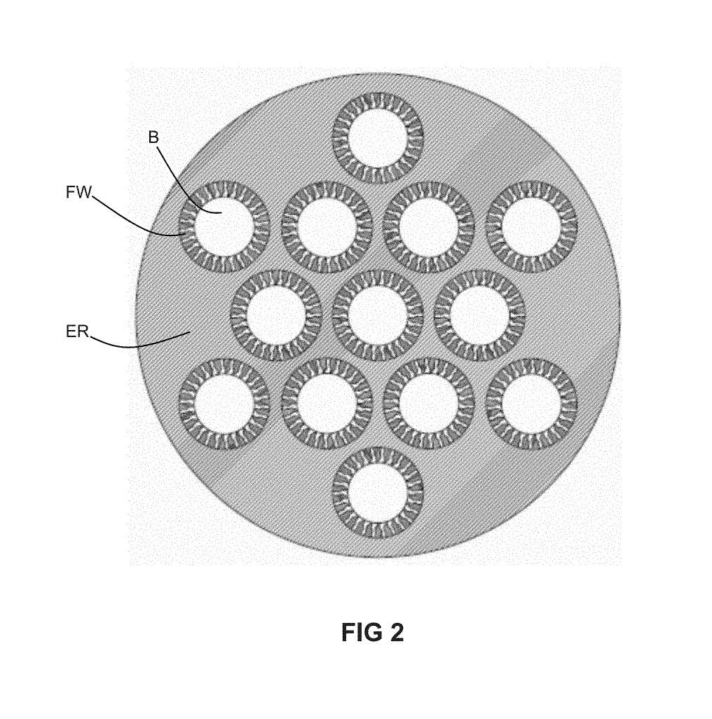

As seen in FIG. 1, for conventional hollow fiber membrane tubesheets, each having a fiber wall FW surrounding a bore B, the encapsulating resin ER does not penetrate into the fiber wall FW. In contrast and as seen in FIG. 2, in the hollow fiber membrane tubesheets made according to the first technique, the encapsulating resin ER substantially penetrates into the fiber walls FW but not into the bores B.

In a second technique, the porous walls of hollow fibers in the tubesheet region are impregnated with a material that restricts/blocks the aggressive components of the feed gas stream from contacting the interface between hollow fibers and the impregnating resin. The impregnation process is carried out by treating the terminal tubesheet through severed open ends of hollow fibers with a low viscosity solution of the impregnating agent. After the solvent is evaporated, the dissolved material is deposited/solidifies in the porous walls of the hollow fibers. The material deposited in the porous walls of hollow fibers renders the walls less porous and restricts access of aggressive gas components to the fiber/resin interface. The impregnation solution should wet the porous structure of hollow fibers. Upon solvent evaporation the dissolved material is deposited within the fiber walls without substantially blocking fiber bores. The impregnation can be carried out utilizing an inorganic or polymeric material. In the case of a polymeric material used for pore impregnation, it typically exhibits a low oxygen gas permeability coefficient. The oxygen gas permeability coefficient of the impregnation material is typically below 5 Barrer, most typically below 1 Barrer. In this second technique, the encapsulating resin may be any known in the field of hollow fiber membranes and typically is an epoxy.

In a third technique, the porous walls of the hollow fibers in the tubesheet region are rendered partially or completely dense (i.e., non-porous) thus restricting access of gaseous components of the feed stream to the encapsulating material at the exterior surface of the hollow fibers.

In one embodiment of the method of use of the invention, the aircraft fuel tank flammability reduction method comprises the following steps: feeding pressurized air into the hollow fiber membrane air separation module (wherein the hollow fiber membrane is capable of selective oxygen permeation; allowing the fed pressurized air to enter into the hollow fiber membrane bores; removing some of the oxygen from the feed air as an oxygen-enriched permeate stream from the air separation module so as to produce nitrogen-enriched air as a non-permeate stream from the air separation module, wherein pores of hollow fiber walls within at least one tubesheet of the module have been blocked by a material that limits access of the feed air to the interface between an exterior surface of the hollow fibers and the encapsulating resin within the tubesheet.

In another embodiment of the method of use of the invention, the aircraft fuel tank flammability reduction method comprises the following steps: feeding pressurized air into hollow fiber membrane air separation module (wherein the hollow fiber membrane is capable of selective oxygen permeation); allowing the fed pressurized air to enter into the hollow fiber membrane bores; removing some of the oxygen from the feed air as an oxygen-enriched permeate stream from the air separation module so as to produce nitrogen-enriched air as a non-permeate stream from the air separation module, wherein at least one tubesheet of the hollow fiber membrane module is formed from a resinous material and said resinous material has penetrated into porous walls of hollow fibers in tubesheet section limiting access of the feed air to the interface between an exterior surface of the hollow fibers and the encapsulating resin within the tubesheet.

In a further embodiment of the method of use of the invention, an aircraft fuel tank flammability reduction method comprises the following steps: feeding pressurized air into hollow fiber membrane air separation module (wherein the hollow fiber membrane is capable of selective oxygen permeation); allowing the fed pressurized air to enter into the hollow fiber membrane bores; removing some of the oxygen from the feed air as an oxygen-enriched permeate stream from the air separation module so as to produce nitrogen-enriched air as a non-permeate stream from the air separation module, wherein at least one tubesheet of said module has been treated to render hollow fiber walls denser to limit access of the feed air to the interface between exterior surfaces of the hollow fibers and the encapsulating resin within the tubesheet.

It was found surprisingly that the mechanical properties of ASM tubesheets and the long term operational characteristics and durability of the ASM can be improved by limiting the access of feed air to the interface between the exterior surface of the hollow fibers and the encapsulating resin in the tubesheet. The ASM of the present invention exhibits improved stable long term performance and the ability to operate at higher operating temperatures without premature tubesheet deterioration and the consequent ASM failure. In comparison to conventional ASMs, the invention extends the useful life of ASMs and enables of operation at elevated temperatures. The ASM devices of the invention may be operated with an air feed temperature above 60° C., and in some cases, above 80° C.

Both ASM's feed air end tubesheet and the product end tubesheet can be manufactured using any of the above three techniques. However, it is relatively more important to apply one of those techniques to at least the feed end tubesheet because it is subject to harsher operating conditions.

### EXAMPLES

### Comparative Example

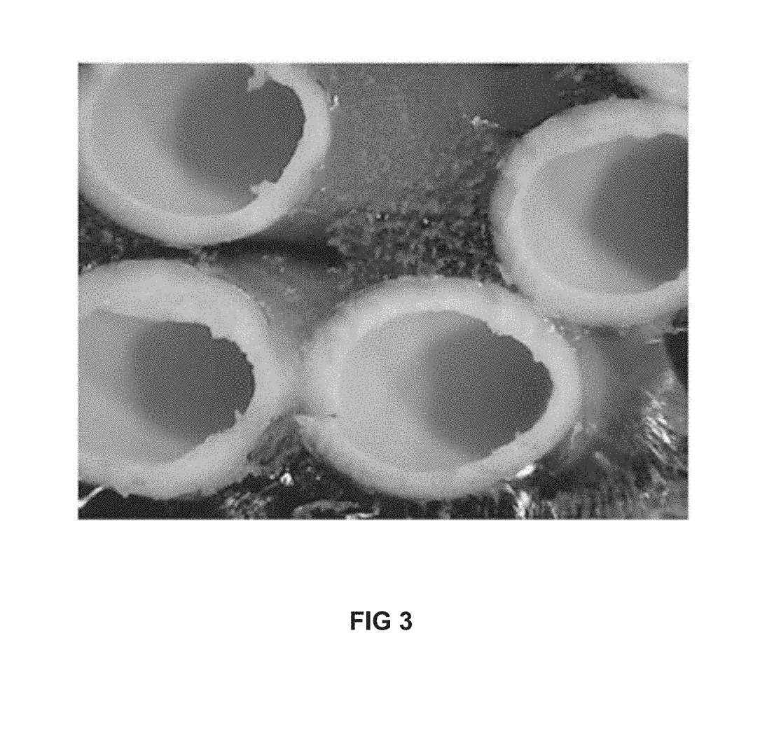

A substantially cylindrical bundle of polysulfone hollow fiber gas separation membranes of about 7 inches in diameter was potted in an epoxy resin to form the terminal tubesheet. The epoxy resin was formulated as follows. Hardener used in preparation of the resin formulation was Amicure 101 (manufactured by Air Products). The Hardener composition was further combined with the epoxy resin comprised of 75:25 weight ratio of EPON 160 and MY510 (manufactured by Hexion and Huntsman, respectively). The Resin to Hardener ratio was 3.0 (pbw). The components were mixed using Caframo mechanical stirrer at 1000 RPM for 30 minutes. This mixture was injected into the hollow fiber bundle to form the terminal tubesheet. The tubesheet mechanical property was tested following ASTM D638-10 specifications and the failure pattern was examined using scanning electron microscope. The scanning electron microscopic cross sectional view of the hollow fiber tubesheet prepared according to this procedure is shown in FIG. 3. The epoxy resin does not penetrate hollow fiber wall. The pores in hollow fiber walls are not filled with the encapsulating resin. The feed air has unobstructed access to fiber/resin interface through open hollow fiber bores.

### Example 1

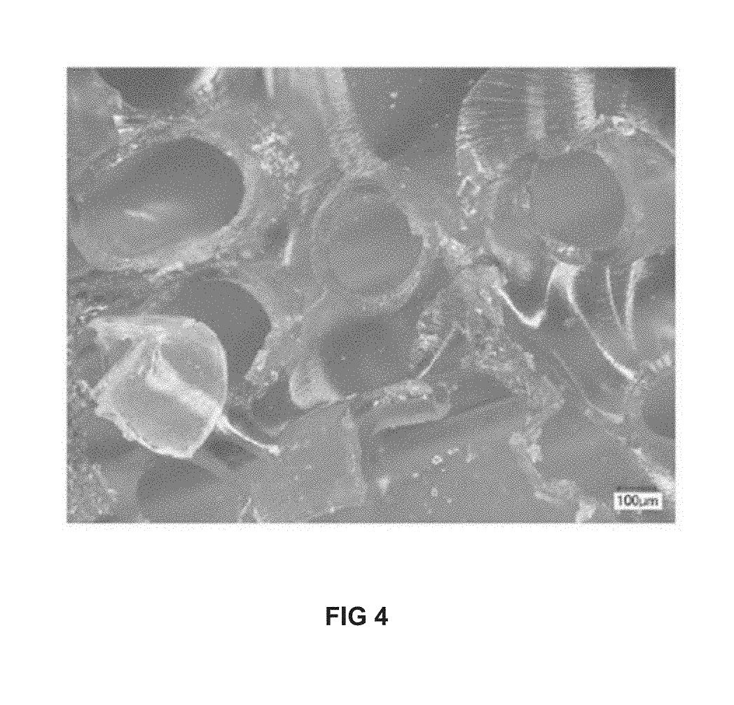

A substantially cylindrical bundle of polysulfone hollow fiber gas separation membranes of about 7 inches in diameter was potted in an epoxy resin to form the terminal tubesheet. The epoxy resin was formulated as follows. The hardener mixture comprised Amicure 101, Epikure W (manufactured by Air products and Hexion respectively) and Gamma-aminopropyltriethoxy silane (Momentive Silquest A-1100 Silane, CAS-No: 919-30-2) in the following weight ratio 1:1:0.1 (parts by weight) and prepared by mixing all these hardener components using Caframo mechanical stirrer at 500 RPM for 30 minutes. The hardener composition was further combined with NV75 epoxy resin (75:25 weight ratio of EPON 160 and MY510 manufactured by Hexion and Huntsman, respectively) in Resin to hardener ratio of 1:0.34 prepared using Caframo mechanical stirrer at 1000 RPM for 30 minutes. This mixture was injected into the hollow fiber bundle to form the terminal tubesheet and the tubesheet mechanical property was studies. The microscopic cross sectional view of the hollow fiber tubesheet prepared according to this procedure is shown in FIG. 4. The pores in the hollow fiber walls are filled with the encapsulating resin while the bores remain open and allow for unobstructed flow of the feed gas into hollow fibers. Without being bound by any particular theory, we believe that the types of epoxy resin formulations described in the Specification results in improved miscibility at the fiber/resin interface. In this manner, we believe that this improved miscibility increased the tensile strength of the tubesheet. Additionally, we believe that the improved miscibility increased the homogeneity of the formulation at this interface, again increasing the tensile strength of the tubesheet.

### Example 2

A substantially cylindrical bundle of polysulfone hollow fiber gas separation membranes of about 7 inches in diameter was potted in an epoxy resin to form the terminal tubesheet. The epoxy resin was formulated as follows. Hardener mixture comprised of Amicure 101 and Epikure W (manufactured by Air products and Hexion respectively) in the following weight ration 1:0.35 was prepared by mixing the components. The Hardener composition was further combined with EPON 862 epoxy resin (manufactured by Hexion) in Resin to Hardener ratio of 1:0.27 using Caframo mechanical stirrer at 1000 RPM for 30 minutes. This mixture was applied to the terminal end of the hollow fiber bundle to form the tubesheet. The pores in hollow fiber walls in the tubesheet were filled with the encapsulating resin. The hollow fiber bores were open and allowed for unobstructed flow of the feed gas into hollow fibers.

The mechanical properties of the tubesheet prepared according to Comparative Example and Examples 1 and 2 were measured and compared. The tensile strength and the modulus were measured following the ASTM D638-10 specification. Dog bone samples used were cut from identical sections of tubesheets. The tensile testing results are summarized in the table below

| | Tensile Strength | | Tensile Modulus |
|---|---|---|---|
| Example | (ksi) | Tensile Strain (%) | (ksi) |
| Comparative | 1.19 ± 0.07 | 1.77 ± 0.22 | 119 ± 15 |
| Example | | | |
| Example 1 | 2.44 ± 0.22 | 1.82 ± 0.26 | 156 ± 11 |
| Example 2 | 2.31 ± 0.07 | 1 ± 0.07 | 275 ± 35 |

As examples of the invention, the prepared tubesheets of Examples 1 and 2 exhibit an increase in the tensile strength as compared to tubesheet of the Comparative Example (prepared by the conventional method. The tubesheets of Example 1 and the Comparative Example were subjected to an air atmosphere at 88° C. for 3000 hours and their mechanical properties after exposure were re-measured. The tensile strength of the tubesheet of Example 1 was 50% higher than that of the Comparative Example.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within the range.

All references identified herein are each hereby incorporated by reference into this application in their entireties, as well as for the specific information for which each is cited.

What is claimed is:

1. An aircraft fuel tank flammability reduction method comprising the steps of:
feeding pressurized air into hollow fiber membrane air separation module comprising one or more cured tubesheets disposed at a terminal end(s) of the module and also one or more hollow fiber membranes, each of the tubesheets comprising resin encapsulating the membrane(s), each of the membrane(s) having a bore, the hollow fiber membrane(s) being capable of selective oxygen permeation;
allowing the pressurized air to be fed into bore(s);
removing some of the oxygen from the feed air as an oxygen-enriched permeate stream from the air separation module so as to produce nitrogen-enriched air as a non-permeate stream from the air separation module, wherein access of feed air to an interface between an exterior surface of the hollow fibers and the encapsulating resin within the tubesheet is restricted.

2. The method of claim 1, wherein the nitrogen-enriched air is directed into the fuel tank on board an aircraft.

3. The method of claim 1, wherein pores of walls of the membrane(s) within at least one tubesheet of the module have been blocked by a material that limits access of the feed air to an interface between an exterior surface of the hollow fibers and the encapsulating resin within the tubesheet.

4. The method of claim 3, wherein the nitrogen-enriched air is directed into the fuel tank on board an aircraft.

5. The method of claim 1, wherein at least one tubesheet has been treated to render walls of the hollow fiber(s) in the tubesheet denser to limit access of the feed air to an interface between exterior surfaces of the hollow fiber(s) and the encapsulating resin within the tubesheet.

6. The method of claim 5, wherein the nitrogen-enriched air is directed into the fuel tank on board an aircraft.

7. The method of claim 5, wherein the material that limits access of air to interface between hollow fibers and encapsulating resin is deposited from a solution through the hollow fiber bore(s).

8. The method of claim 7, wherein the material is an inorganic substance or a polymer.

9. The method of claim 8, wherein the material is a polymer having an oxygen gas permeability coefficient below 1 Barrer.

10. The method of claim 1, wherein the encapsulating resin of at least one of the tubesheet(s) penetrates into porous walls of hollow fibers in the tubesheet limiting access of the feed air to an interface between an exterior surface of the hollow fibers and the encapsulating resin within the tubesheet(s).

11. The method of claim 10, wherein the nitrogen-enriched air is directed into the fuel tank on board an aircraft.

12. The method of claim 10, wherein at least 50% of a pore volume of the hollow fiber membrane(s) in the tubesheet are filled with encapsulating resin.

13. The method of claim 12, wherein the impregnation of porous walls is substantially uniform across a diameter of the tubesheet and tubesheet thickness.

14. The method of claim 10, wherein at least 90% of a pore volume of the hollow fiber membrane(s) in the tubesheet are filled with encapsulating resin.

15. The method of claim 14, wherein the impregnation of porous walls is substantially uniform across a diameter of the tubesheet and tubesheet thickness.

16. The method of claim 10, wherein a pore volume of portions of the hollow fiber(s) in the tubesheet is reduced by at least 50% compared to remaining portions of the hollow fiber(s).

17. The method of claim 10, wherein a pore volume of portions of the hollow fiber(s) in the tubesheet is reduced by at least 80% compared to remaining portions of the hollow fiber(s).

18. The method of claim 1, wherein the tubesheet is the feed gas side tubesheet.

19. The method of claim 1, wherein a temperature of the feed air is between 45 and 120° C.
